(19) United States
(12) Patent Application Publication
(10) Pub. No.: US 2010/0012664 A1
(43) Pub. Date: Jan. 21, 2010

(54) FRP PRESSURE VESSEL AND BOTTOM PLATE TYPE DISTRIBUTOR, FABRICATION APPARATUS AND FABRICATION METHOD OF THE SAME

(75) Inventor: Jian Xin Xie, Shanghai (CN)

Correspondence Address: HAMRE, SCHUMANN, MUELLER & LARSON, P.C., P.O. BOX 2902, MINNEAPOLIS, MN, 55402-0902, US

(73) Assignee: WAVE CYBER (SHANGHAI) CO., LTD., Shanghai (CN)

(21) Appl. No.: 12/427,088

(22) Filed: Apr. 21, 2009

(30) Foreign Application Priority Data
Jul. 16, 2008 (CN) 200810040603.9

(51) Int. Cl. F17C 1/02; F17C 1/08; B67D 5/54; B29C 49/04

(52) U.S. Cl. 220/588; 220/592; 137/154; 425/532; 264/540

(57) ABSTRACT

A bottom plate type distributor which may be provided integrally at a internal bottom of FRP pressure vessels. The distributor is composed of a distribution plate and a bowl-shaped inlet dome. The distribution plate comprises an outlet connected to a water outlet pipe, a reinforcing structure around the outlet, a water distribution slot structure supported by the reinforcing structure, a ring structure around the water distribution slot structure, and first connecting structures on the ring structure for connecting the inlet dome. The inlet dome comprises a bowl-shaped body, a receiving structure provided on the concave surface of the bowl-shaped body for connecting said reinforcing structure, second connecting structures around the bowl-shaped body respectively connecting the first connecting structure, an inlet in the center of the bowl-shaped body which is on the same center line as the outlet; and a process hole. This invention also provides an FRP pressure vessel containing such bottom plate type distributor, its fabrication equipment and fabrication method.

### FIELD OF THE INVENTION

This invention relates to an FRP pressure vessel and bottom plate type distributor, fabrication apparatus and fabrication method of the same.

### RELATED ART

Most distributors adopted for FRP (Fiberglass-Reinforced Plastics) pressure vessels currently are parts separated from the internal walls. Such distributor is mounted after the vessel is shaped. The shape and size of the distributor are limited by the size of the outlet of the vessel. Therefore, the water distribution area of the distributor is relatively small under certain volume. Additionally, there are some distributors which are hard to install.

### SUMMARY OF THE INVENTION

The objective of this invention is to provide a built-in bottom plate type distributor inside a FRP pressure vessel to increase the water distribution area of the FRP pressure vessel, an FRP pressure vessel, and fabrication apparatus and fabrication method of the same.

In order to achieve the above-mentioned objective, the bottom plate type distributor of this invention being suitable to be provided integrally at the internal bottom of a FRP pressure vessel, the bottom plate type distributor characterized in that comprises a distribution plate and a bowl-shaped inlet dome, the distribution plate comprising an outlet connected to a water outlet pipe, reinforcing structures around the outlet, a water distribution slot structure supported by the reinforcing structures, a ring structure around the water distribution slot structure; and a first connecting structure provided on the ring structure for connecting the inlet dome, the inlet dome comprising a bowl-shaped body, receiving structures on the concave surface of the bowl-shaped body for connecting said reinforcing structures, second connecting structures around the bowl-shaped body for connecting said first connecting structures, an inlet provided in the center of the bowl-shaped body, the central axis of said inlet being collinear with the central axis of said outlet, and pierces for gripping a blow mold parison during a blow mold process.

In one preferable embodiment of said bottom plate type distributor of the invention, the reinforcing structures comprises several reinforcing ribs distributed radially in the radial direction of the distribution plate and rib plates with pins, and said receiving structure comprises a pluralities of insert holes, and said pins are respectively inserted into said insert holes.

In one preferable embodiment of said bottom plate type distributor of the invention, the water distribution slot structure comprises several curved water distribution slots evenly distributed along the circumferential direction of the distribution plate, and gap width of each of said water distribution slots is in the range between 0.3 mm and 0.4 mm.

In one preferable embodiment of said bottom plate type distributor of the invention, said ring structure is the edge of the distributor plate and the first connecting structure on said ring structure comprises several spaced protuberant clasps, the second connecting structure comprises catching slots provided on the edge of the inlet dome, and said clasps are connected to said catching slots.

The FRP pressure vessel of this invention with a distributor provided at the internal bottom of its liner, the FRP pressure vessel characterized in that the distributor comprises a distribution plate and a bowl-shaped inlet dome, the distribution plate comprising an outlet connected to a water outlet pipe, reinforcing structures around the outlet, a water distribution slot structure supported by the reinforcing structures, a ring structure around the water distribution slot structure, and a first connecting structure provided on the ring structure for connecting the inlet dome; the inlet dome comprising a bowl-shaped body, receiving structures on the concave surface of the bowl-shaped body for connecting said reinforcing structures, second connecting structures around the bowl-shaped body for connecting said first connecting structures, an inlet provided in the center of the bowl-shaped body, the central axis of said inlet being collinear with the central axis of said; and pierces for gripping a blow mold parison during a blow mold process, and the FRP pressure vessel also comprises a sealing assembly for sealing said inlet.

In one preferable embodiment of the above mentioned FRP pressure vessel, the water distribution slot structure comprises several curved water distribution slots evenly distributed along the circumferential direction of the distribution plate, and gap width of each of said water distribution slots is in the range between 0.3 mm and 0.4 mm.

In one preferable embodiment of the above mentioned FRP pressure vessel, said ring structure is the edge of the distributor plate and the first connecting structure on said ring structure comprises a pluralities of spaced protuberant clasps, the second connecting structure comprises snap slots provided on the edge of the inlet dome, and said clasps are respectively connected to said snap slots.

In one preferable embodiment of the above mentioned FRP pressure vessel, said reinforcing structures comprise several reinforcing ribs distributed radially in the radial direction of the distribution plate and rib plates with pins, and said receiving structure comprises a pluralities of insert holes, said pins are respectively inserted into said insert holes.

The blow mold apparatus for fabricating the above mentioned FRP pressure vessel of the invention is characterized in that the blow mold apparatus comprises a parison stretcher for extruding parison, a nozzle-sealing base under the parison stretcher for carrying the distributor, a claw having an opening status and a closing status, at the closing status the claw covering the distributor, a machine platform being movable up and down along the axial direction of nozzle-sealing base for carrying said claw; and a mold equipment for a process of expanding parison into the liner of the FRP pressure vessel.

The fabrication method of the invention for fabricating the FRP pressure vessel using the above mentioned blow mold apparatus is characterized in that it comprises:

Step a, placing a bottom plate type distributor onto the nozzle-sealing base by using clamping tool;

Step b, raising the machine platform to a position where the claw is able to cover the bottom plate type distributor;

Step c, closing the claw so that the claw covers the bottom plate type distributor, extruding a cylinder shaped parison from the parison stretcher and covering the claw with the bottom of said cylinder shaped parison;

Step d, opening the claw to expand the diameter of the cylinder shaped parison to make the diameter of the parison larger than the outside diameter of the distributor, meanwhile, lowering the machine platform so that the claw pulls the cylinder shaped parison down to cover the distributor;

Step e, closing the mold equipment and filling the cylinder shaped parison with air when the mold is being closed or about to be closed so that the parison is expanded to be the shape of the cavity of the mold equipment; and

Step f, opening the mold equipment after cooling the liner and pulling out the liner.

One of advantages of this invention is that a pre injection molded bottom plate type distributor with large water distribution area is embedded to the inner bottom of the liner when the liner is being molded. This frees the user from installing distributor and avoids reduction of water distribution area of the distributor caused by installation of distributor.

### DESCRIPTION OF DRAWINGS

FIG. 1 is the semi-sectional view of the FRP pressure vessel of this invention.

FIG. 2 is the partial enlarged view of position A in FIG. 1.

FIG. 3 is the perspective view of the bottom plate type distributor in FIG. 2, wherein only half of the distributor being shown in order to show its internal structure clearly.

FIG. 4 is the semi-sectional view of the distribution plate of the bottom plate type distributor in FIG. 2.

FIG. 5 is the perspective view of the bottom plate type distributor in FIG. 2.

FIG. 6 is the semi-sectional view of the inlet dome of the bottom plate type distributor in FIG. 2.

FIG. 7 is the perspective view of the inlet dome in FIG. 2.

FIG. 8 is the schematic drawing of a blow mold apparatus for fabricating the FRP pressure vessel of this invention, showing the first procedure of blow mold process.

FIG. 9 is the schematic drawing of the blow mold apparatus for fabricating the FRP pressure vessel of this invention, showing the second procedure of blow mold process.

FIG. 10 is the schematic drawing of the blow mold apparatus for fabricating the FRP pressure vessel of this invention, showing the third procedure of blow mold process.

FIG. 11 is the schematic drawing of the blow mold apparatus for fabricating the FRP pressure vessel of this invention, showing the fourth procedure of blow mold process.

FIG. 12 is the schematic drawing of the blow mold apparatus for fabricating the FRP pressure vessel of this invention, showing the fifth procedure of blow mold process.

FIG. 13 is the schematic drawing of the blow mold apparatus for fabricating the FRP pressure vessel of this invention, showing the sixth procedure of blow mold process.

### DETAILED DESCRIPTION OF EXEMPLARY EMBODIMENTS

Detailed description of this invention will be provided below with preferable embodiments. It should be noted that although the terminologies used in the following description are selected from terminologies known to and used by those persons skilled in the art, some terminologies are chosen by the applicant by his own judgment and thus the detailed meaning of such terminologies shall be understood based on the meaning intended to be disclosed from this invention. For example, hole has the same meaning as short slot. Words describing directions such as up, down, internal and external are applicable to the product (apparatus or system) for its normal operation status.

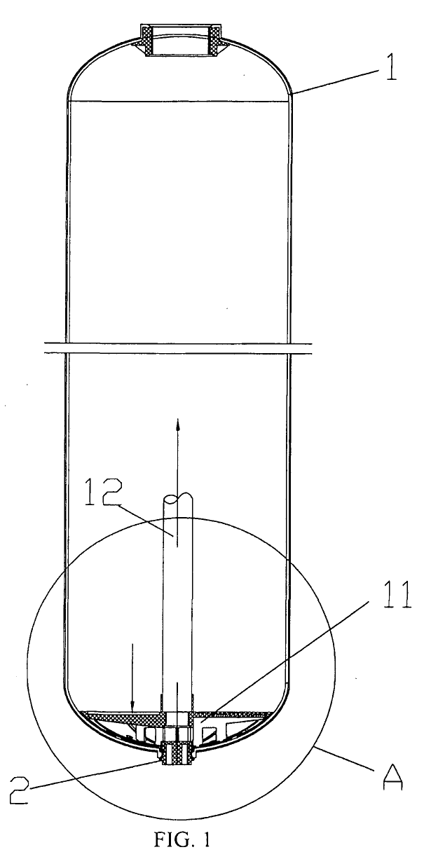

As is shown in FIG. 1, water penetrates into large area of a bottom plate type distributor 11 after being treated by a media (such as granular water treatment material) and flows out from its outlet and is discharged by a valve (not shown in the figure) through an outlet pipe 13.

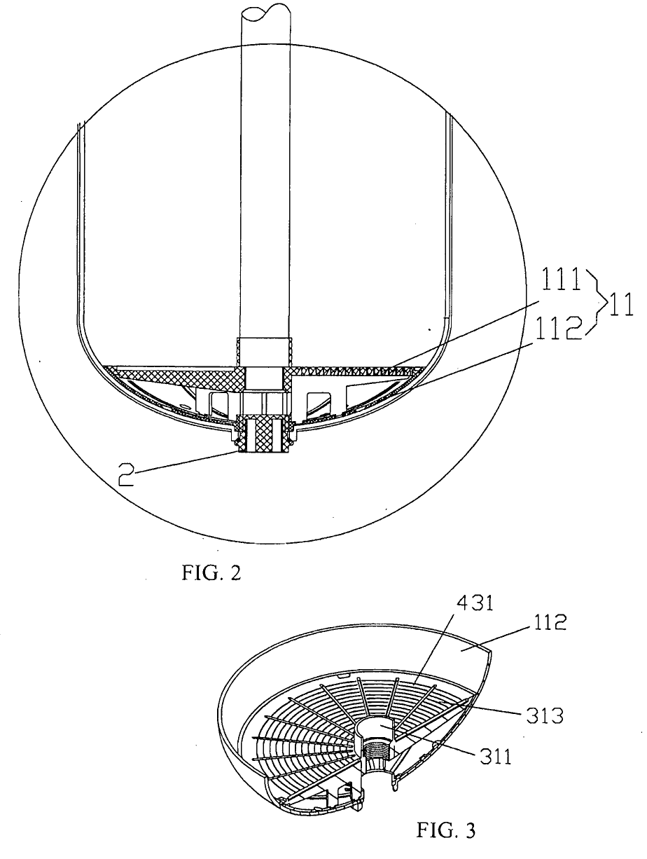

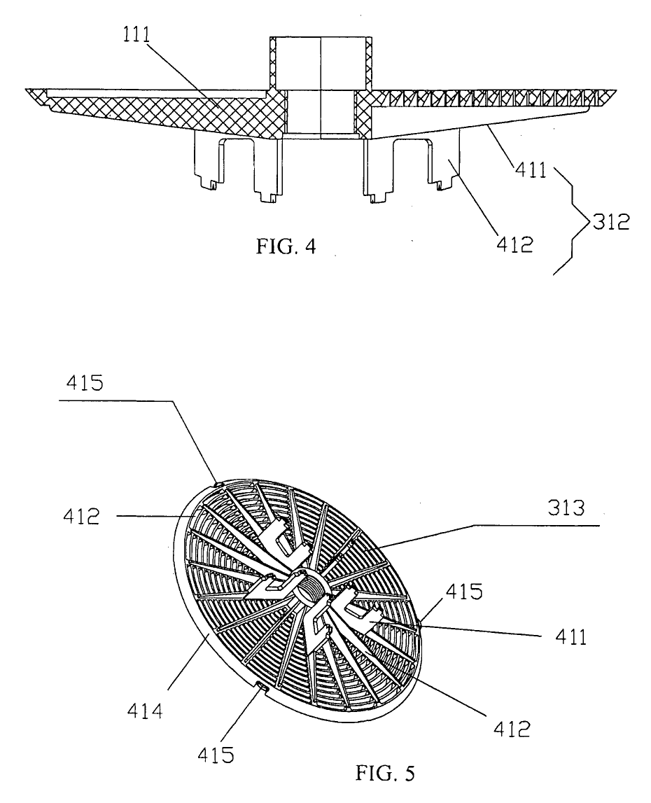

With reference to FIG. 2 and FIG. 3, the bottom plate type distributor 11 comprises a distribution plate 111 in upper position and an inlet dome 112 in lower position. With reference to FIG. 4 and FIG. 5, the distribution plate 111 comprises an outlet 311 connected to the water outlet pipe 12, reinforcing structures 312 around the outlet 311, a water distribution slot structure 313 supported by reinforcing structures 312, ring structure 414 around the water distribution slot structure 313, and first connecting structures 415 on ring structure 414 for connecting inlet dome 112.

In the embodiment shown in FIG. 4 and FIG. 5, outlet 311 is a round pipe joint (with female thread), reinforcing structure 312 comprises several reinforcing ribs 412 distributed radially in the radial direction of distribution plate 111 and long rib plates 411 for connecting inlet dome 112, and water distribution slot structure 313 comprises several curved water distribution slots 431 evenly distributed along the circumferential direction of distribution plate 111. Gap width of said water distribution slots 431 is in the range between 0.3 nm, and 0.4 mm. Ring structure 414 is function as the edge of distributor plate 111 and first connecting structure 415 on ring structure 414 comprises several spaced protuberant clasps.

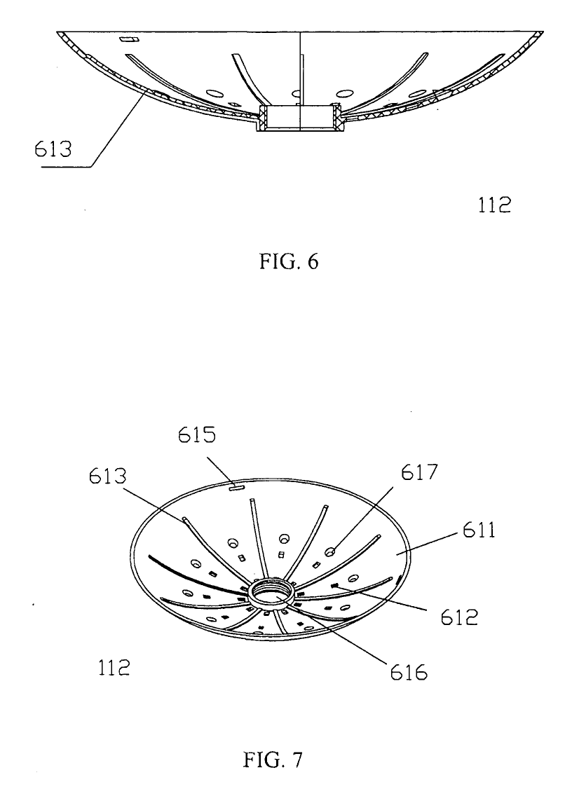

As is shown in FIG. 6 and FIG. 7, inlet dome 112 comprises an bowl-shaped body 611 which having a shape of bowl, a receiving structure 612 on the concave surface of bowl-shaped body 611 for receiving and bearing reinforcing rib structure 312, a second connecting structure 615 around bowl-shaped body 611 for connecting first connecting structure 415, an inlet 616 in the center of bowl-shaped body 611, the central axis of inlet 616 being collinear with the central axis of outlet 311, and pierces 617 for gripping the blow mold parison during blow mold process.

In the embodiment shown in FIG. 6 and FIG. 7, receiving structures 612 are slots for inserting rib plates 414, second connecting structures 615 are catching slots 615 distributed on the edge of bowl-shaped body 611, inlet 616 is a pipe joint with female thread, and pierces 617 are preferably tapered holes 617. Additionally, multiple radial ribs 613 are provided with inlet dome 112 to strengthen the structure of inlet dome 112.

Backing to FIG. 1, as will be set forth in the context below, a screwed hole (said female thread hole of inlet 616) is provided at the bottom of the FRP pressure vessel due to process requirements. Therefore, an embodiment of the FRP pressure vessel of this invention comprises the sealing assembly which comprises seal ring and plug screw 2 as well as the liner 1 and the above mentioned bottom plate type distributor.

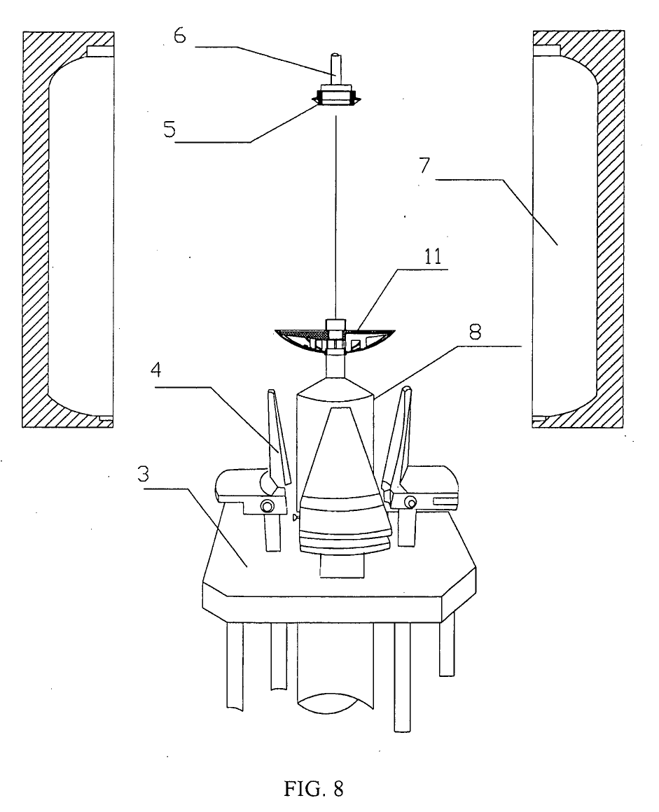

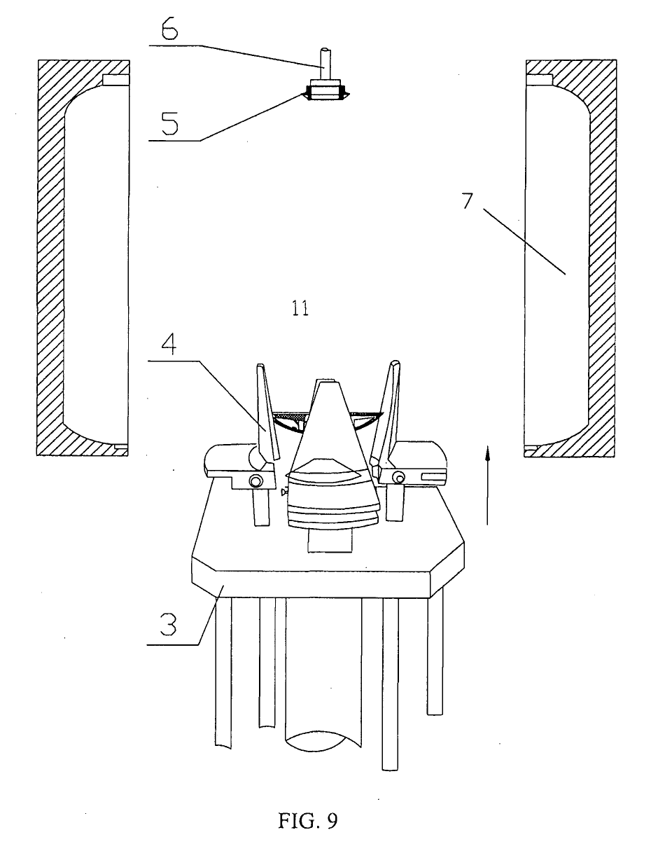

As is shown in FIG. 8, a blow mold apparatus for the above mentioned FRP pressure vessel comprises a parison stretcher 6 for extruding parison, a nozzle-sealing base 8 under parison stretcher 6 for supporting bottom plate type distributor 11, a claw 4 having an opening status and an closing status, in the closing status to claw 4 covering bottom plate type distributor 11, a machine platform 3 being movable up and down along the axial direction of nozzle-sealing base 8 for carrying and supporting material claw 4, and a mold equipment 7 for a process of expanding parison into the liner of the FRP pressure vessel. In this figure, mold equipment 7 is only illustrated with mold and it's driving assembly and fixing assembly are not shown.

Referring to FIG. 8 to FIG. 13, a fabrication method for the FRP pressure vessel of the present invention using the above mentioned blow mold apparatus comprises the following procedures:

(1) As is shown in FIG. 8, providing a lifting mechanism connected with the parison stretcher 6 (having feed port) of the blow mold apparatus, mounting screwed joint 5 to the lifting mechanism through a clamping device, and mounting bottom plate type distributor 11 to nozzle-sealing base 8 through a special clamp (product sold in the market);

(2) Raising the machine platform 3 as shown in FIG. 9;

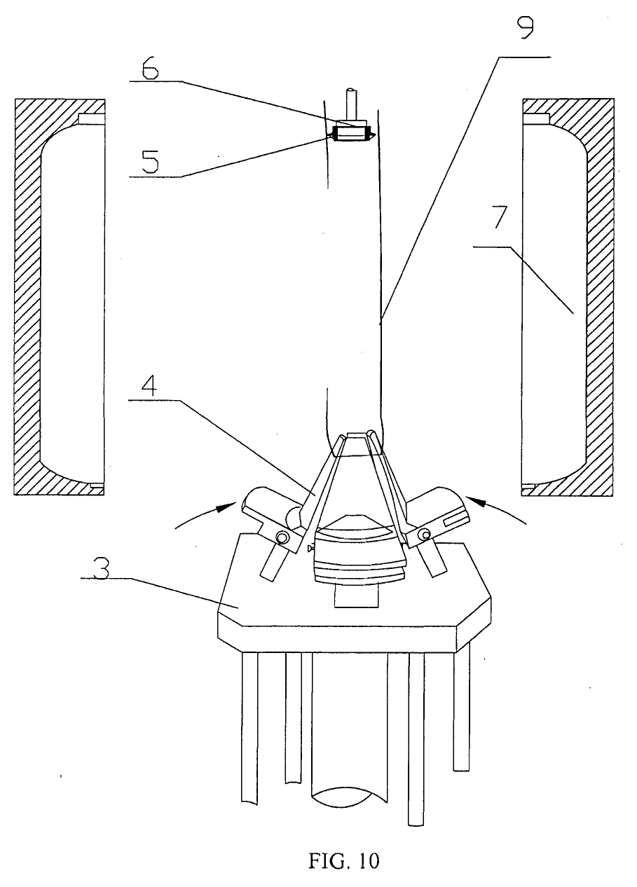

(3) Closing claw 4 to cover bottom plate type distributor 11, and extruding cylinder shaped parison 9 through the parison stretcher 6 as shown in FIG. 10;

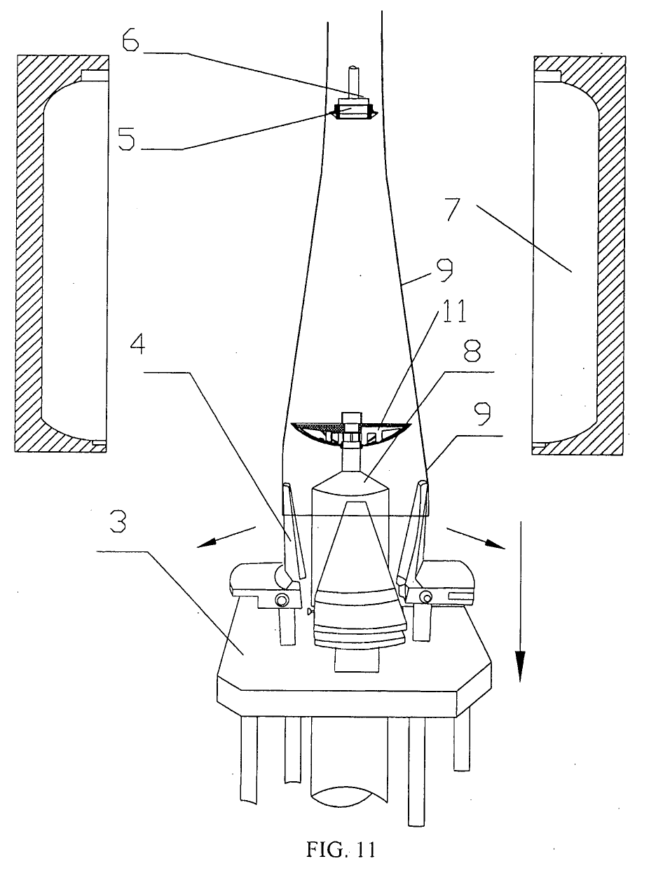

(4) Turning claw 4 outwards to expand diameter of parison 9 so that the diameter of parison 9 is larger than the diameter of bottom plate type distributor 11; Meanwhile, lowering machine platform 3 so that claw 4 pulls parison 9 down and covers bottom plate type distributor 11 as shown in FIG. 11;

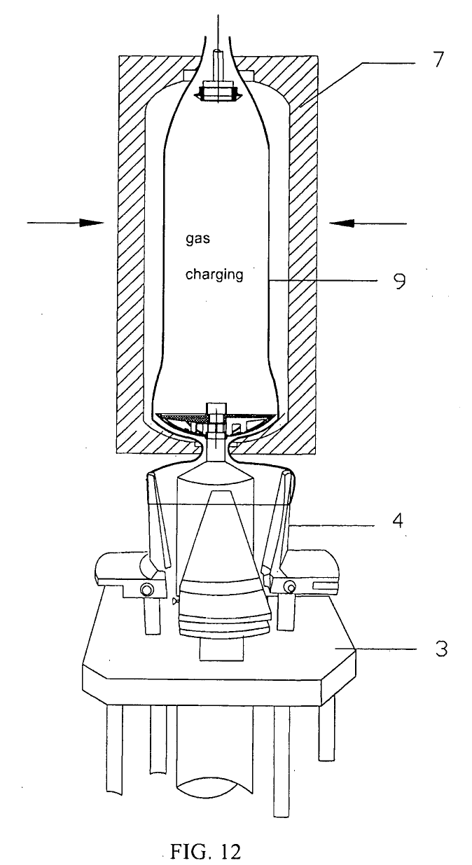

(5) Starting to close mold 7, while the mold is about to be closed, start filling parison 9 with air as shown in FIG. 12;

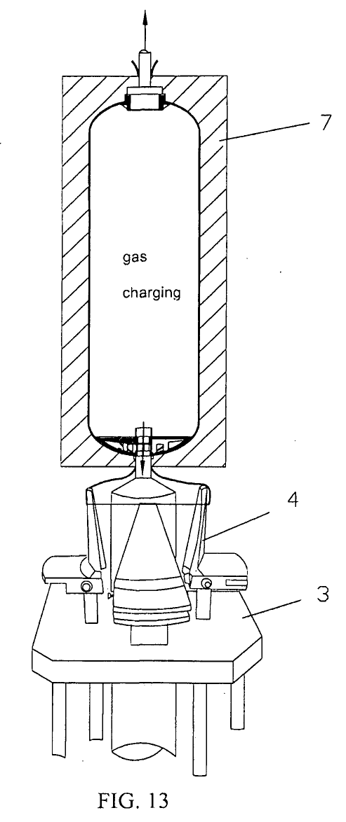

(6) Completely closing mold 7, and continuing to fill parison 9 with air by using parison stretcher 6 so that parison 9 is expanded to be the shape of the cavity of mold 7 as shown in FIG. 13.

(7) Opening the mold after cooling formation of the liner, pulling out the liner to finish the blow mold process.

Although description of this invention is made with reference to the embodiments, the personal in the art shall be noted that the embodiments above-mentioned are only used to illustrate this invention and shall understand that modifications and variations may be made without deviating from this invention in general. Therefore, the above mentioned embodiments are not considered as the limit to this invention. As long as the essential spiritual range of this invention is not exceeded, the modifications and variations of the embodiments will still fall within the range of claims of this invention.

1. A bottom plate type distributor being suitable to be provided integrally at the internal bottom of a FRP pressure vessel, the bottom plate type distributor characterized in that comprises a distribution plate and a bowl-shaped inlet dome,
the distribution plate comprising:
an outlet connected to a water outlet pipe;
reinforcing structures around the outlet;
a water distribution slot structure supported by the reinforcing structures;
a ring structure around the water distribution slot structure; and
a first connecting structure provided on the ring structure for connecting the inlet dome;
the inlet dome comprising:
a bowl-shaped body;
receiving structures on the concave surface of the bowl-shaped body for connecting said reinforcing structures;
second connecting structures around the bowl-shaped body for connecting said first connecting structures;
an inlet provided in the center of the bowl-shaped body, the central axis of said inlet being collinear with the central axis of said outlet; and
pierces for gripping a blow mold parison during a blow mold process.

2. The bottom plate type distributor of claim 1 characterized in that the reinforcing structures comprises several reinforcing ribs distributed radially in the radial direction of the distribution plate and rib plates with pins, and said receiving structure comprises a pluralities of insert holes, and said pins are respectively inserted into said insert holes.

3. The bottom plate type distributor of claim 1 characterized in that the water distribution slot structure comprises several curved water distribution slots evenly distributed along the circumferential direction of the distribution plate, and gap width of each of said water distribution slots is in the range between 0.3 mm and 0.4 mm.

4. The bottom plate type distributor of claim 1 characterized in that said ring structure is the edge of the distributor plate and the first connecting structure on said ring structure comprises several spaced protuberant clasps, the second connecting structure comprises catching slots provided on the edge of the inlet dome, and said clasps are connected to said catching slots.

5. An FRP pressure vessel with a distributor provided at the internal bottom of its liner, the FRP pressure vessel characterized in that the distributor comprises a distribution plate and a bowl-shaped inlet dome, the distribution plate comprising:
an outlet connected to a water outlet pipe;
reinforcing structures around the outlet;
a water distribution slot structure supported by the reinforcing structures;
a ring structure around the water distribution slot structure; and
a first connecting structure provided on the ring structure for connecting the inlet dome;
the inlet dome comprising:
a bowl-shaped body;
receiving structures on the concave surface of the bowl-shaped body for connecting said reinforcing structures;
second connecting structures around the bowl-shaped body for connecting said first connecting structures;
an inlet provided in the center of the bowl-shaped body, the central axis of said inlet being collinear with the central axis of said; and
pierces for gripping a blow mold parison during a blow mold process;
and the FRP pressure vessel also comprises a sealing assembly for sealing said inlet.

6. The FRP pressure vessel of claim 5 characterized in that said reinforcing structures comprise several reinforcing ribs distributed radially in the radial direction of the distribution plate and rib plates with pins, and said receiving structure comprises a pluralities of insert holes, said pins are respectively inserted into said insert holes.

7. The FRP pressure vessel of claim 5 characterized in that the water distribution slot structure comprises several curved water distribution slots evenly distributed along the circumferential direction of the distribution plate, and gap width of each of said water distribution slots is in the range between 0.3 mm and 0.4 mm.

8. The FRP pressure vessel of claim 5 characterized in that said ring structure is the edge of the distributor plate and the first connecting structure on said ring structure comprises a pluralities of spaced protuberant clasps, the second connecting structure comprises snap slots provided on the edge of the inlet dome, and said clasps are respectively connected to said snap slots.

9. A blow mold apparatus for fabricating the FRP pressure vessel of claim 5, characterized in that the blow mold apparatus comprises:
a parison stretcher for extruding parison;
a nozzle-sealing base under the parison stretcher for carrying the distributor;
a claw having an opening status and a closing status, at the closing status the claw covering the distributor;
a machine platform being movable up and down along the axial direction of nozzle-sealing base for carrying said claw; and
a mold equipment for a process of expanding parison into the liner of the FRP pressure vessel.

10. A fabrication method for fabricating a FRP pressure vessel using the blow mold apparatus of claim 9 characterized in that the method comprises:
Step a, placing a bottom plate type distributor onto the nozzle-sealing base by using clamping tool:
Step b, raising the machine platform to a position where the claw is able to cover the bottom plate type distributor;
Step c, closing the claw so that the claw covers the bottom plate type distributor, extruding a cylinder shaped parison from the parison stretcher and covering the claw with the bottom of said cylinder shaped parison;
Step d, opening the claw to expand the diameter of the cylinder shaped parison to make the diameter of the parison larger than the outside diameter of the distributor, meanwhile, lowering the machine platform so that the claw pulls the cylinder shaped parison down to cover the distributor; and
Step e, closing the mold equipment and filling the cylinder shaped parison with air when the mold is being closed or about to be closed so that the parison is expanded to be the shape of the cavity of the mold equipment;
Step f, opening the mold equipment after cooling the liner and pulling out the liner.
